(19) United States
(12) Patent Application Publication
(10) Pub. No.: US 2024/0292148 A1
(43) Pub. Date: Aug. 29, 2024

(54) HEADSET AND METHOD FOR CONTROLLING DIRECTIVITY OF CALL MICROPHONE

(71) Applicant: Panasonic Intellectual Property Management Co., Ltd., Osaka (JP)

(72) Inventor: Shinichiro KURIHARA, Hyogo (JP)

(21) Appl. No.: 18/571,598

(22) PCT Filed: Mar. 28, 2022
(86) PCT No.: PCT/JP2022/014855

§ 371 Date: Dec. 18, 2023

(30) Foreign Application Priority Data
Jul. 20, 2021 (JP) 2021-119990

(51) Int. Cl. H04R 1/40; H04R 1/08; H04R 1/10; H04R 3/00

(52) U.S. Cl. CPC H04R 1/406; H04R 1/08; H04R 1/1008; H04R 3/005; H04R 2203/12

(57) ABSTRACT

A headset includes: a first housing that is worn on one of ears of a person; a second housing that is worn on the other of the ears; a plurality of call microphones that are provided in at least one of the first housing or the second housing; a speaker that is provided in the first housing; a sound collection microphone that is provided in the second housing; and a controller that outputs a first voice signal to the speaker. The speaker outputs a sound based on the first voice signal. The sound collection microphone collects the sound output from the speaker via a head of the person, and outputs, to the controller, a second voice signal based on the sound collected. The controller controls directivities of the plurality of call microphones based on an amount of delay of the second voice signal relative to the first voice signal.

### TECHNICAL FIELD

The present disclosure relates to a headset which is worn on a human body and a method for controlling the directivity of a call microphone.

### BACKGROUND ART

A headset disclosed in Patent Literature (PTL) 1 includes an arm which protrudes from one end side of a headband, a first microphone which is provided at a tip of the arm, and a second microphone which is provided closer to the side of the root of the arm than the first microphone. The first microphone is disposed on a substantially straight line passing through the mouth of a user and the second microphone. In the headset described above, a voice can be made clear even in a noisy environment.

### CITATION LIST

### Patent Literature

[PTL 1] Japanese Unexamined Patent Application Publication No. 2019-83406

### SUMMARY OF INVENTION

### Technical Problem

The present disclosure provides a headset and the like which can pick up a voice emitted from the mouth according to the width of the head of a person even when the width of the head of the person wearing the headset varies.

### Solution to Problem

A headset in the present disclosure includes: a first housing that is worn on one of ears of a person; a second housing that is worn on an other of the ears; a plurality of call microphones that are provided in at least one of the first housing or the second housing; a speaker that is provided in the first housing; a sound collection microphone that is provided in the second housing; and a controller that outputs a first voice signal to the speaker, the speaker outputs a sound based on the first voice signal, the sound collection microphone collects the sound output from the speaker via a head of the person, and outputs, to the controller, a second voice signal based on the sound collected, and the controller controls directivities of the plurality of call microphones based on an amount of delay of the second voice signal relative to the first voice signal.

A method for controlling a directivity of a call microphone in the present disclosure includes: outputting a sound based on a first voice signal from a speaker disposed on a side of one of ears of a person; collecting the sound output from the speaker via a head of the person and outputting a second voice signal based on the sound collected, using a sound collection microphone disposed on a side of an other of the ears; and controlling directivities of a plurality of call microphones provided on both sides or one side of the ears based on an amount of delay of the second voice signal relative to the first voice signal.

### Advantageous Effects of Invention

A headset in the present disclosure is effective for picking up a voice emitted from the mouth according to the width of the head of a person.

### BRIEF DESCRIPTION OF DRAWINGS

FIG. 1 is a diagram showing a headset in a comparative example.

FIG. 2 is a schematic view showing a call system which includes a headset in an embodiment.

FIG. 3 is a diagram schematically showing the headset in the embodiment.

FIG. 4A is a block configuration diagram of the headset in the embodiment.

FIG. 4B is a diagram schematically showing a part of the block configuration diagram shown in FIG. 4A and a communication terminal shown in FIG. 2.

FIG. 5 is a diagram showing an example of standard data stored in a memory of the headset.

FIG. 6 is a diagram showing an example of homeomorphic coefficients stored in the memory of the headset.

FIG. 7 is a diagram showing another example of the homeomorphic coefficients stored in the memory of the headset.

FIG. 8 is a flowchart showing a method for controlling the directivities of call microphones in the headset.

FIG. 9 is a timing chart showing an example of the operation of the headset.

FIG. 10 is a diagram schematically showing a headset in Variation 1 of the embodiment.

FIG. 11 is a diagram schematically showing a headset in Variation 2 of the embodiment.

FIG. 12 is a diagram schematically showing a headset in Variation 3 of the embodiment.

FIG. 13 is a block configuration diagram of a part of the headset in Variation 3 of the embodiment.

FIG. 14 is a diagram showing another example of the homeomorphic coefficients stored in the memory of the headset.

FIG. 15 is a diagram showing another example of the homeomorphic coefficients stored in the memory of the headset.

### DESCRIPTION OF EMBODIMENTS

### (Circumstances Leading to the Present Disclosure)

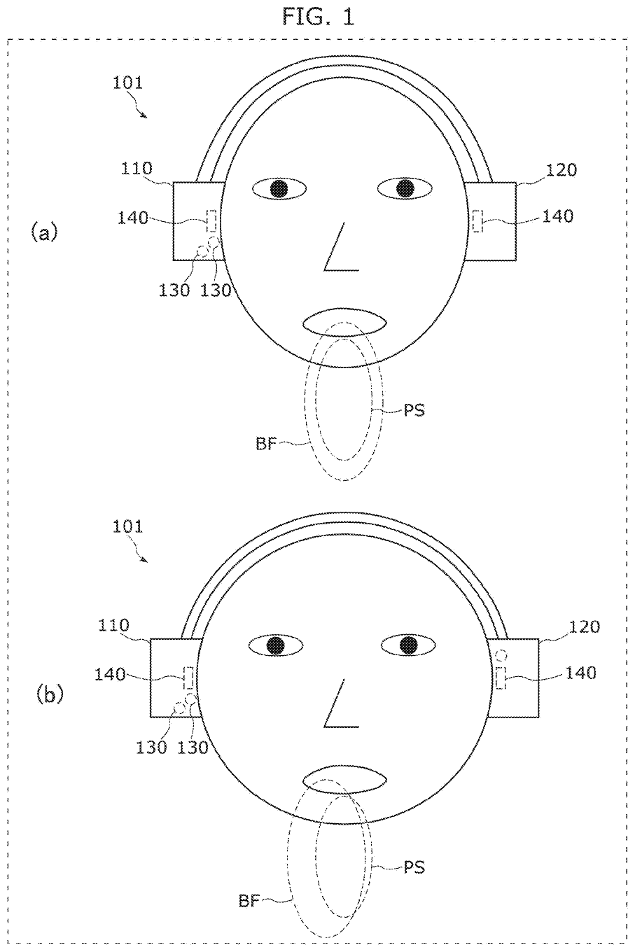

Circumstances leading to the present disclosure will be described with reference to FIG. 1.

FIG. 1 is a diagram showing headset 101 in a comparative example. In part (a) in FIG. 1, an example where headset 101 is worn on a person having a standard head size is shown, and in part (b) in FIG. 1, an example where headset 101 is worn on a person having a larger head size than the standard head size is shown.

Headset 101 in the comparative example includes two housings 110 and 120, speakers 140 provided in housings 110 and 120, and a plurality of call microphones 130 provided in housing 110 of two housings 110 and 120.

As shown in part (a) in FIG. 1, when headset 101 is worn on the person having the standard head size, call microphones 130 are previously set such that beamform BF indicating the directivities of call microphones 130 overlaps position coordinates PS of a voice emitted from the mouth of the person.

However, the size of the head on which headset 1 is worn varies from person to person. For example, as shown in part (b) in FIG. 1, when headset 101 is worn on a person having a large width of the head, the position of beamform BF is displaced from position coordinates PS of a voice emitted from the mouth. Hence, in headset 101 in the comparative example, it is disadvantageously difficult to pick up the voice emitted from the mouth.

By contrast, in a headset in the present disclosure, even when the width of the head of a person wearing the headset varies, it is possible to appropriately pick up a voice emitted from the mouth according to the width of the head of the person.

An embodiment will be described in detail below with reference to drawings as necessary. However, a detailed description beyond necessity may be omitted. For example, the detailed description of already well-known matters and the repeated description of substantially the same configuration may be omitted. This is intended to avoid unnecessary redundancy in the following description and to facilitate the understanding of those skilled in the art. The accompanying drawings are provided to give a description necessary for the full understanding of the present disclosure by those skilled in the art, and are not intended to limit features in the scope of claims.

### Embodiment

### [Configuration of Call System Including Headset]

In the embodiment, a headset and a call system which control the directivities of microphones in real time while making a call will be described.

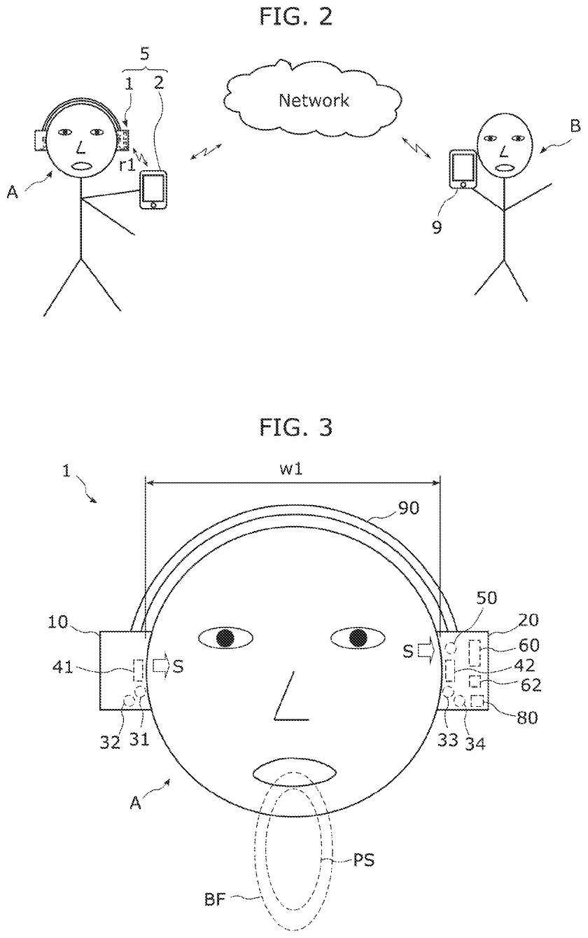

The configuration of the call system which includes the headset in the embodiment will first be described with reference to FIG. 2.

FIG. 2 is a schematic view showing call system 5 which includes headset 1 in the embodiment. In the figure, communication terminal 9 of user B which is the communication partner of user A is also shown.

Call system 5 shown in FIG. 2 is, for example, an intercommunication system, and includes headset 1 and communication terminal 2.

Headset 1 is worn on the head of user A so that user A makes a freehand call. Headset 1 is connected to communicate with communication terminal 2 by wireless r1. Wireless r1 is, for example, a communication method using a 2.4 GHz frequency band, such as Bluetooth (registered trademark).

Communication terminal 2 is a device which is owned by user A, and is, for example, a portable terminal such as a smartphone. Communication terminal 9 is a device which is owned by user B.

Communication terminals 2 and 9 can communicate with each other via a network. For example, a voice emitted from user B is input to communication terminal 2 via communication terminal 9 and the network, and is further input to headset 1 by wireless r1. A voice emitted from user A is picked up by call microphones provided in headset 1, is transmitted to communication terminal 2 by wireless r1, and is further transmitted to communication terminal 9 of user B via the network. In this way, users A and B can make a call using communication terminals 2 and 9. In order to appropriately transmit the details of the call made by user A to user B, it is necessary to appropriately pick up the voice emitted from user A by the call microphones.

### [Configuration of Headset]

The configuration of headset 1 in the embodiment will be described with reference to FIGS. 3 to 6.

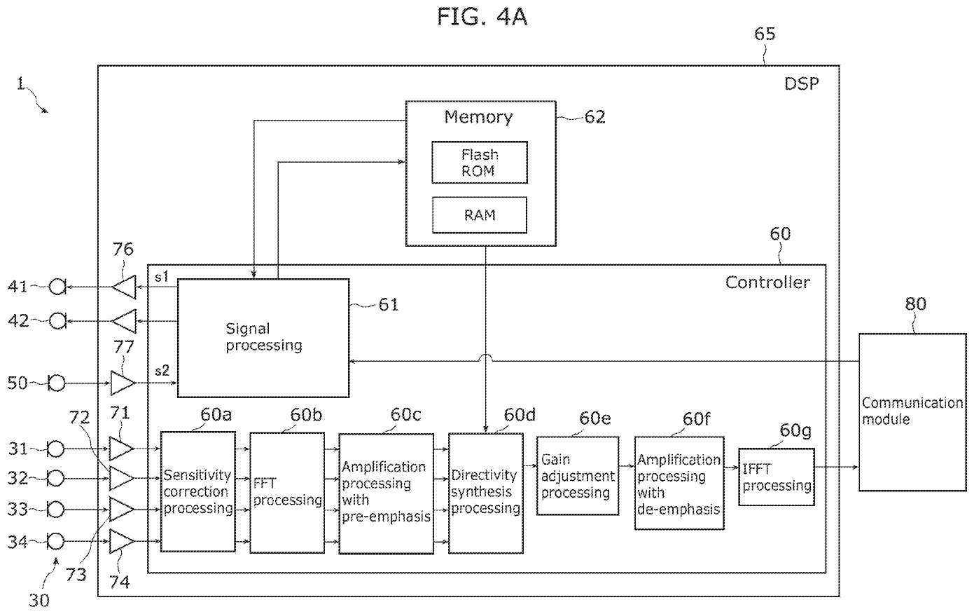

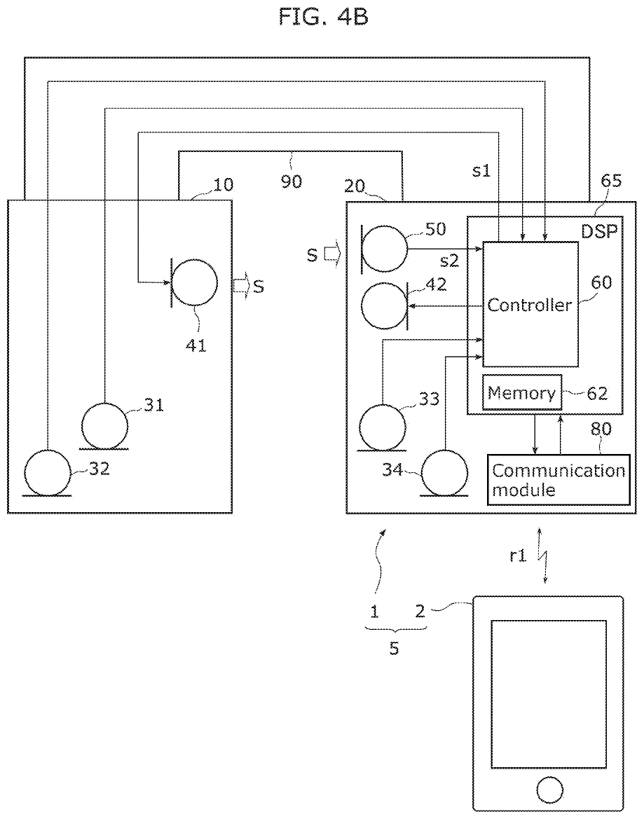

FIG. 3 is a diagram schematically showing headset 1 in the embodiment. FIG. 4A is a block configuration diagram of headset 1. FIG. 4B is a diagram schematically showing a part of the block configuration diagram shown in FIG. 4A and communication terminal 2 shown in FIG. 2. In FIG. 3, the ears of a person are omitted.

As shown in FIG. 3, headset 1 includes headband 90, first housing 10, second housing 20, a plurality of call microphones 31 to 34, speakers 41 and 42, sound collection microphone 50, and controller 60. As shown in FIGS. 3, 4A, and 4B, headset 1 includes memory 62 and communication module 80. Call microphones 31 to 34, speakers 41 and 42, sound collection microphone 50, memory 62, and communication module 80 are wired to connect to controller 60.

As shown in FIG. 3, headband 90 is curved substantially in the shape of an arc, and is elastically deformable. First housing 10 is connected to one end side of headband 90, and second housing 20 is connected to the other end side. Inside headband 90, wiring is provided to connect controller 60, speaker 41, and call microphones 31 and 32.

Each of first housing 10 and second housing 20 includes, for example, a case-shaped housing and an ear pad attached to the housing (not shown).

First housing 10 is worn on one of the ears of the person. Second housing 20 is worn on the other of the ears. Each of first housing 10 and second housing 20 may be worn to cover an auricle or may be worn in contact with the auricle. First housing 10 and second housing 20 are worn on the ears, and thus first housing 10 and second housing 20 are opposite each other through the head of the person, with the result that the head of the person is sandwiched between first housing 10 and second housing 20.

Call microphones 31 to 34 are provided in at least one of first housing 10 or second housing 20. Call microphones 31 to 34 are a microphone array in which two or more microphones are provided as a set. In this example, two call microphones 31 and 32 are provided in first housing 10, and two call microphones 33 and 34 are provided in second housing 20. Each of call microphones 31 to 34 is an omnidirectional microphone with no directivity in a state where the call microphone is not controlled by controller 60 or the like. In the following description, two or all of call microphones 31 to 34 may be referred to as call microphones 30. A sound picked up by call microphones 30 is output to controller 60.

Communication module 80 is connected to communicate with external communication terminal 2 by wireless r1. Communication module 80 acquires a signal about the voice picked up by call microphones 30 via controller 60, and transmits the signal to communication terminal 2. Communication module 80 outputs, to controller 60, a signal about a voice transmitted from communication terminal 2.

Controller 60 and memory 62 are provided inside second housing 20. Controller 60 and memory 62 may be provided not inside second housing 20 but inside first housing 10.

Controller 60 shown in FIG. 4A includes a central processing unit (CPU). Controller 60 has the function of performing signal processing 61. Memory 62 includes a flash random access memory (RAM), a read only memory (ROM), and the like. Controller 60 and memory 62 are mounted in digital signal processor (DSP) 65.

In memory 62, programs for controlling the operation of headset 1 are stored. In memory 62, data for calculating the width of the head, data for controlling the directivities of call microphones 30, and the like are stored. This will be described later.

The CPU executes a program stored in memory 62 to realize each of functional blocks in controller 60. Hence, signal processing 61 in controller 60 is realized as software processing on the program. Each of the functional blocks in controller 60 may be mounted as hardware.

Controller 60 performs control processing described below in order to control the directivities of call microphones 30. In this example, signal processing 61 is described as processing which is performed by controller 60.

Controller 60 outputs first voice signal s1 based on the signal about the voice output from communication module 80.

For example, the signal about the voice is transmitted from communication terminal 9 of user B, is input to communication module 80 via the network and communication terminal 2, and is thereafter input to controller 60. The signal about the voice may be a voice signal of moving images acquired via the network. The voice signal may be a voice signal of music stored in memory 62 of communication terminal 2 or may be a signal of a single wavelength stored in memory 62. The signal about the voice may be a voice signal which is received from communication terminal 9 or may be a voice signal of contents reproduced by communication terminal 2.

First voice signal s1 output from controller 60 is converted into an analog signal by DA converter 76, and is output to speaker 41.

Speaker 41 is provided in first housing 10, and speaker 42 is provided in second housing 20. Speaker 42 does not necessarily need to be provided in headset 1. In at least a method of using speaker 42 in the present embodiment, speaker 42 does not output a sound.

Speaker 41 outputs sound S based on first voice signal s1 output from controller 60. Specifically, speaker 41 outputs the sound toward the ear on which first housing 10 is worn. Sound S output from speaker 41 is transmitted through the ear, the brain, and the other ear in this order to sound collection microphone 50 provided in second housing 20.

Sound collection microphone 50 is provided inside second housing 20. Sound collection microphone 50 collects sound S output from speaker 41 via the head of the person. Sound collection microphone 50 is an omnidirectional microphone whose directivity is not controlled. Sound collection microphone 50 may be a feedback microphone which is used to cancel surrounding noise.

Sound collection microphone 50 outputs second voice signal s2 based on collected sound S. Since second voice signal s2 is generated from sound S based on first voice signal s1, second voice signal s2 includes a signal waveform based on first voice signal s1. Second voice signal s2 output from sound collection microphone 50 is converted into a digital signal by AD converter 77, and is output to controller 60.

Controller 60 uses first voice signal s1 output by itself and second voice signal s2 input to itself, and thereby controls the directivities of call microphones 30. Specifically, controller 60 acquires amount of delay d1 of second voice signal s2 relative to first voice signal s1 to control the directivities of call microphones 30.

Amount of delay d1 is a time difference between a time when controller 60 outputs first voice signal s1 and a time when second voice signal s2 is input to controller 60. In other words, amount of delay d1 is an input/output delay time when the head is regarded as one input/output device. Amount of delay d1 is not limited to the time difference, and may be a phase difference between the signal waveform of first voice signal s1 and the signal waveform of second voice signal s2. Since sound S output from speaker 41 is transmitted through the interior of the head in a sufficiently short time relative to the frequency of sound in an audible range, and is collected by sound collection microphone 50, even when a phase difference is used, it is possible to sufficiently calculate amount of delay d1.

Controller 60 calculates the width of the head of the person wearing headset 1 based on amount of delay d1 and the data stored in memory 62.

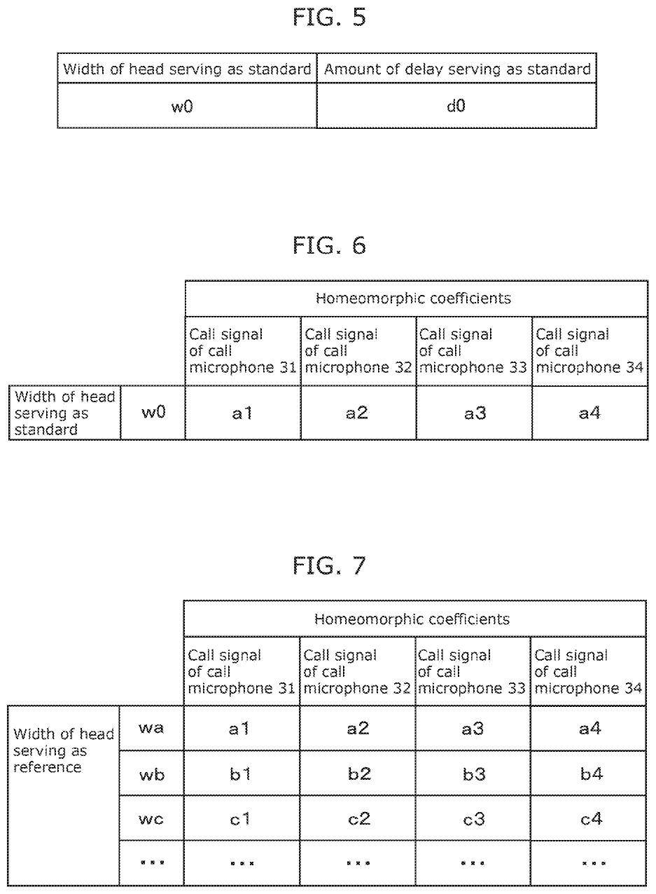

FIG. 5 is a diagram showing an example of standard data stored in memory 62 of headset 1. FIG. 5 shows amount of delay do of second voice signal s2 relative to first voice signal s1 when headset 1 is worn on a person having width w0 of the head serving as a standard. Width w0 of the head serving as the standard is, for example, the width of the head of a person having a standard head size.

Controller 60 compares amount of delay d1 acquired and amount of delay do serving as the standard to calculate width w1 of the head of the person wearing headset 1. For example, when amount of delay d1 acquired is 1.1 times amount of delay do serving as the standard, controller 60 makes a calculation such that width w1 of the head is 1.1 times width w0 of the head serving as the standard. For example, when amount of delay d1 acquired is 0.9 times amount of delay do serving as the standard, controller 60 makes a calculation such that width w1 of the head is 0.9 times width w0 of the head serving as the standard. Since most of a medium in the head is water, it is assumed that there is no individual difference in the transmission speed of sound S inside the head.

Controller 60 estimates position coordinates PS of a voice emitted from the mouth of the person wearing headset 1 based on width w1 of the head calculated. A method for estimating position coordinates PS is as described below.

For example, it is defined that the midpoint of a line segment connecting left and right ears is an origin, an X-axis is in the left/right direction of the head, a Y-axis is in the up/down direction thereof, and a Z-axis is in the forward/backward direction thereof. In this way, the ears are located on the X-axis, and speakers 41 and 42 are located on the X-axis in a state where the headset is worn on the head. Here, it is assumed that position coordinates PS of the voice are on a YZ plane, and Y and Z coordinates are located to have predetermined values (position coordinates PS (0, y0, z0) of the voice). Here, y0 and z0 may be predetermined values as described above (the position of position coordinates PS of the voice is fixed) or may be calculated from width w1 of the head. Since the positions of the call microphones are known in this coordinate system (for example, w1/2, 0, 0), homeomorphic coefficients are controlled such that the directivities of the call microphones are directed in a direction toward position coordinates PS of the voice from the positions of the call microphones. In the present embodiment, the homeomorphic coefficients are determined from width w1 of the head, and thus it is possible to estimate position coordinates PS of the voice with reference to tables in FIGS. 5 to 7.

Controller 60 controls the directivities of call microphones 30 so as to correspond to position coordinates PS of the voice which are estimated. The directivities of call microphones 30 are controlled by changing homeomorphic coefficients for causing call signals output from call microphones 30 to be homeomorphic.

FIG. 6 is a diagram showing an example of the homeomorphic coefficients stored in memory 62 of headset 1.

As shown in FIG. 6, in memory 62, a plurality of homeomorphic coefficients a1, a2, a3, and a4 for causing call signals output from call microphones 31 to 34 to be homeomorphic are stored. These homeomorphic coefficients a1 to a4 are homeomorphic coefficients corresponding to width w0 of the head serving as the standard.

Controller 60 compares width w1 of the head calculated and width w0 of the head serving as the standard to correct homeomorphic coefficients a1 to a4 stored in memory 62, and stores, in memory 62, the homeomorphic coefficients corrected. Then, controller 60 controls the directivities of call microphones 30 based on the corrected homeomorphic coefficients. Specifically, controller 60 corrects homeomorphic coefficients a1 to a4 such that beamform BF indicating the directivities of call microphones 30 overlaps position coordinates PS of the voice, and thereby controls the directivities of call microphones 30.

Directivity synthesis processing of controller 60 and the like will be described below with reference to FIG. 4A.

Voice signals which are collected by four call microphones 31 to 34 are output as call signals to DSP 65. The call signals input to DSP 65 are respectively converted into digital signals by AD converters 71, 72, 73, and 74, and are output to controller 60. The call signals converted into the digital signals are subjected to sensitivity correction processing 60a, fast Fourier transform (FFT) processing 60b, and amplification processing 60c with pre-emphasis, and are thereafter subjected to directivity synthesis processing 60d. In directivity synthesis processing 60d, the corrected homeomorphic coefficients described above are used, and thus the phases of the call signals are caused to be homeomorphic. Based on the call signals the phases of which have been caused to be homeomorphic, a main beam and a reference beam are formed, and a beamform with residual sound suppressed is formed. The call signals which have been subjected to directivity synthesis processing 60d are subjected to gain adjustment processing 60e and amplification processing 60f with de-emphasis, are thereafter subjected to inverse fast Fourier transform (IFFT) processing 60g, and are output from controller 60. The call signals output from controller 60 are output to communication module 80. The call signals input to communication module 80 are transmitted to communication terminal 2 by wireless r1. In this way, the voice picked up by call microphones 30 is subjected to the directivity synthesis processing and the like, and is transmitted to communication terminal 2 via communication module 80.

As described above, in the present embodiment, speaker 41 outputs sound S based on first voice signal s1, and sound collection microphone 50 collects sound S output from speaker 41 via the head of the person, and outputs, to controller 60, second voice signal s2 based on collected sound S. Then, controller 60 controls the directivities of call microphones 30 based on amount of delay d1 of second voice signal s2 relative to first voice signal s1. In this way, even when the width of the head of the person wearing headset 1 varies, it is possible to appropriately pick up the voice emitted from the mouth according to the width of the head of the person.

Although in the above description, the example is shown where controller 60 corrects homeomorphic coefficients a1 to a4 stored in memory 62 to control the directivities of call microphones 30, the present disclosure is not limited to this example. For example, controller 60 may use the homeomorphic coefficients in the tables stored in memory 62 to control the directivities of call microphones 30.

FIG. 7 is a diagram showing another example of the homeomorphic coefficients stored in memory 62 of headset 1. FIG. 7 shows a table in which homeomorphic coefficients a1 to a4, b1 to b4, and c1 to c4 corresponding to widths wa, wb, and wc of the head serving as references are stored in memory 62. Controller 60 selects, according to width w1 of the head calculated, the width (for example, wa) of the head serving as the reference from widths wa, wb, and wc of the head serving as the references, and acquires the homeomorphic coefficients (for example, a1 to a4) corresponding to the width of the head selected. Controller 60 may reference the table in FIG. 7 to select a width close to width w1 of the head from widths wa to wc, and select homeomorphic coefficients corresponding to the width of the head selected. Controller 60 may interpolate the homeomorphic coefficients corresponding to the width of the head selected to determine new homeomorphic coefficients. For example, when width w1 of the head is between width wa and width wb, controller 60 may interpolate homeomorphic coefficients a1 to a4 and b1 to b4 corresponding to widths wa and wb to determine new homeomorphic coefficients. As described above, controller 60 may control the directivities of call microphones 30 based on the acquired homeomorphic coefficients.

### [Method for Controlling Directivities of Call Microphones]

A method for controlling the directivities of call microphones in the embodiment will be described.

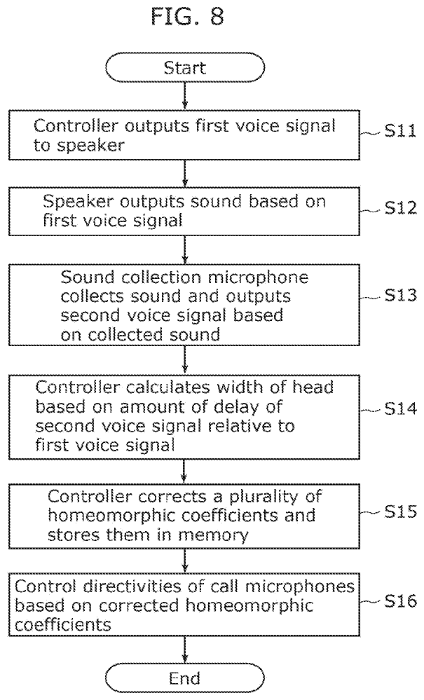

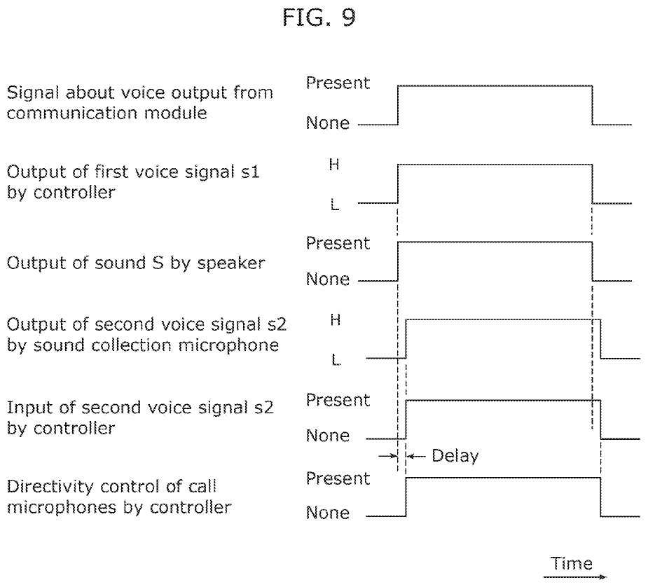

FIG. 8 is a flowchart showing a method for controlling the directivities of call microphones 30 in headset 1. FIG. 9 is a timing chart showing an example of the operation of headset 1.

Controller 60 first outputs first voice signal s1 to speaker 41 (step S11). Specifically, controller 60 generates first voice signal s1 based on a signal about a voice output from communication module 80, and outputs generated first voice signal s1 to speaker 41. The signal about the voice output from communication module 80 is, for example, a signal transmitted from communication terminal 9 of user B which is the communication partner. While the signal about the voice output from communication module 80 is being input, controller 60 continues to output first voice signal s1 to speaker 41 (see FIG. 9).

Speaker 41 outputs sound S based on first voice signal s1 (step S12). Sound S output from speaker 41 is transmitted through the interior of the head to reach sound collection microphone 50.

Sound collection microphone 50 collects sound S passing through the interior of the head, and outputs second voice signal s2 based on collected sound S to controller 60 (step S13). Since sound S output from speaker 41 takes time to be transmitted through the interior of the head and to be input to sound collection microphone 50, second voice signal s2 is input to controller 60 later than the output time of first voice signal s1 (see FIG. 9).

Controller 60 calculates width w1 of the head based on amount of delay d1 of second voice signal s2 relative to first voice signal s1 (step S14). For example, controller 60 calculates width w1 of the head of the person wearing headset 1 based on amount of delay d1 and the standard data stored in memory 62. Amount of delay d1 which can be measured by controller 60 is a time after controller 60 transmits first voice signal s1 to speaker 41 until controller 60 receives second voice signal s2 from sound collection microphone 50. Essentially, it is desirable to measure the amount of delay based on a time after the output of the sound from speaker 41 until the sound is collected by sound collection microphone 50. However, a signal transmission time between controller 60 and speaker 41 and a signal transmission time between sound collection microphone 50 and controller 60 are very short and can be ignored.

The homeomorphic coefficients corresponding to width w0 of the head serving as the standard are stored in memory 62, and thus controller 60 corrects the homeomorphic coefficients stored in memory 62 based on width w1 of the head calculated in step S14. Then, controller 60 stores the corrected homeomorphic coefficients in memory 62 (step S15). In this way, beamform BF suitable for the person wearing headset 1 is set to headset 1. Controller 60 performs the control processing for controlling the directivities of call microphones 30 based on the corrected homeomorphic coefficients while receiving second voice signal s2 output from sound collection microphone 50 (step S16) (see FIG. 9).

These steps S11 to S16 are performed, and thus control of the directivities of call microphones 30 is realized. In this way, even when the width of the head of the person wearing headset 1 varies, it is possible to appropriately pick up the voice emitted from the mouth according to the width of the head of the person. In steps S13 to S15, while controller 60 is receiving second voice signal s2, control of the directivities of call microphones 30 is performed. Hence, for example, even when the position where first housing 10 or second housing 20 is worn on the head is displaced, it is possible to appropriately pick up the voice emitted from the mouth according to the position described above.

### [Variation 1]

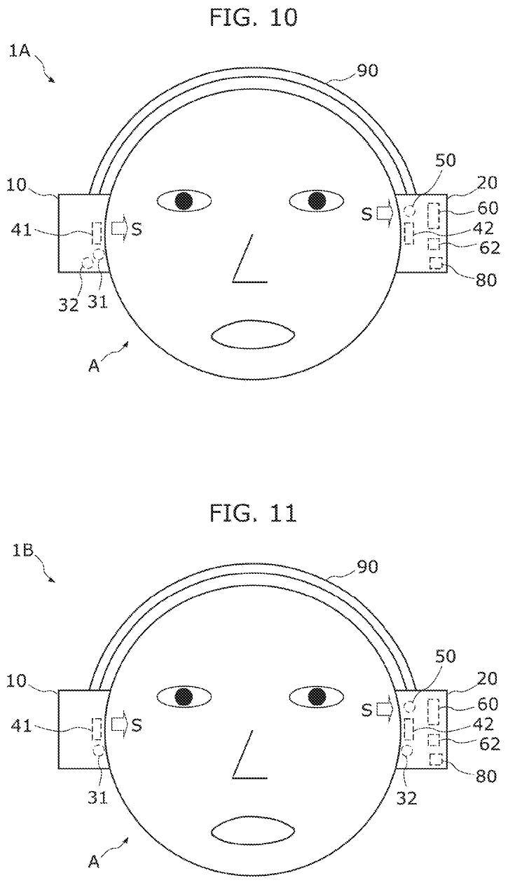

Headset 1A in Variation 1 of the embodiment will be described with reference to FIG. 10. In Variation 1, an example where call microphones 30 are provided only in first housing 10 will be described.

FIG. 10 is a diagram schematically showing headset 1A in Variation 1.

As shown in FIG. 10, headset 1A includes headband 90, first housing 10, second housing 20, a plurality of call microphones 31 and 32, speakers 41 and 42, sound collection microphone 50, and controller 60. Headset 1A also includes memory 62 and communication module 80.

First housing 10, second housing 20, speakers 41 and 42, sound collection microphone 50, controller 60, memory 62, and communication module 80 are the same as in the embodiment.

In headset 1A, call microphones 31 and 32 are provided in first housing 10, and no call microphone is provided in second housing 20.

Even in Variation 1, speaker 41 outputs sound S based on first voice signal s1, and sound collection microphone 50 collects sound S output from speaker 41 via the head of the person, and outputs, to controller 60, second voice signal s2 based on collected sound S. Then, controller 60 controls the directivities of call microphones 31 and 32 based on amount of delay d1 of second voice signal s2 relative to first voice signal s1. In this way, even when the width of the head of the person wearing headset 1A varies, it is possible to appropriately pick up the voice emitted from the mouth according to the width of the head of the person.

Although in FIG. 10, the example is shown where call microphones 31 and 32 are provided only in first housing 10, the present disclosure is not limited to this example. For example, the same is true when call microphones 31 and 32 are provided only in second housing 20, and no call microphone is provided in first housing 10.

### [Variation 2]

Headset 1B in Variation 2 of the embodiment will be described with reference to FIG. 11. In Variation 2, an example where call microphone 31 is provided in first housing 10 and call microphone 32 is provided in second housing 20 will be described.

FIG. 11 is a diagram schematically showing headset 1B in Variation 2.

As shown in FIG. 11, headset 1B includes headband 90, first housing 10, second housing 20, a plurality of call microphones 31 and 32, speakers 41 and 42, sound collection microphone 50, and controller 60. Headset 1B also includes memory 62 and communication module 80.

First housing 10, second housing 20, speakers 41 and 42, sound collection microphone 50, controller 60, memory 62, and communication module 80 are the same as in the embodiment.

In headset 1B, one call microphone 31 is provided in first housing 10, and one call microphone 32 is provided in second housing 20.

Even in Variation 2, speaker 41 outputs sound S based on first voice signal s1, and sound collection microphone 50 collects sound S output from speaker 41 via the head of the person, and outputs, to controller 60, second voice signal s2 based on collected sound S. Then, controller 60 controls the directivities of call microphones 31 and 32 based on amount of delay d1 of second voice signal s2 relative to first voice signal s1. In this way, even when the width of the head of the person wearing headset 1B varies, it is possible to appropriately pick up the voice emitted from the mouth according to the width of the head of the person.

In headset 1B, while controller 60 is receiving second voice signal s2, control of the directivities of call microphones 31 and 32 is performed. Hence, for example, even when the position where first housing 10 or second housing 20 is worn on the head is displaced, it is possible to appropriately pick up the voice emitted from the mouth according to the position described above.

### [Variation 3]

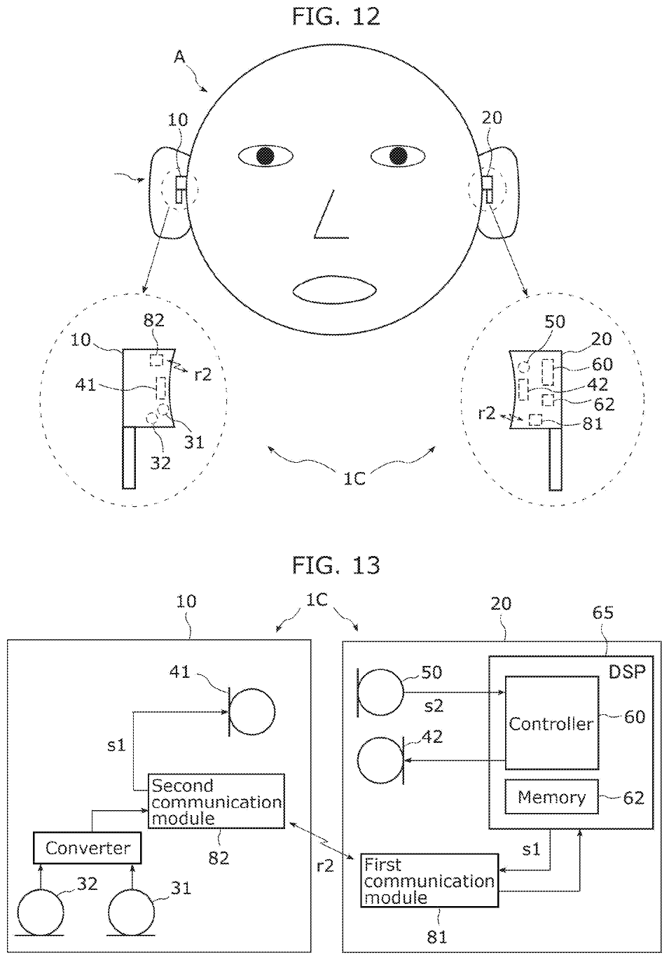

Headset 1C in Variation 3 of the embodiment will be described with reference to FIGS. 12 and 13. In Variation 3, an example where headset 1C is a true wireless stereo (TWS) will be described.

FIG. 12 is a diagram schematically showing headset 1C in Variation 3. FIG. 13 is a block configuration diagram of a part of headset 1C in Variation 3. In FIG. 13, a part such as AD convertors is omitted.

As shown in FIGS. 12 and 13, headset 1C in Variation 3 includes first housing 10, second housing 20, a plurality of call microphones 31 and 32, speakers 41 and 42, sound collection microphone 50, and controller 60. Headset 1C also includes memory 62, first communication module 81, and second communication module 82. Headset 1C in Variation 3 includes no headband.

Speakers 41 and 42, sound collection microphone 50, controller 60, memory 62, and call microphones 31 and 32 are the same as in Variation 1. Although first housing 10 and second housing 20 are different in shape and size from those in Variation 1, the functions of the housings are substantially the same as in Variation 1.

First communication module 81 is provided in second housing 20. First communication module 81 has the same function as communication module 80 in the embodiment, and is connected to communicate with communication terminal 2 by wireless r1.

Second communication module 82 is provided in first housing 10. Second communication module 82 can communicate with first communication module 81 by wireless r2 (see FIG. 13). Wireless r2 is, for example, a communication method such as Bluetooth (registered trademark).

In order to control the directivities of a plurality of call microphones 31 and 32, headset 1C in Variation 3 performs control processing described below.

Controller 60 outputs first voice signal s1 based on a signal about a voice output from first communication module 81. First voice signal s1 output from controller 60 is output to speaker 41 via first communication module 81 and second communication module 82, that is, by wireless r2.

Speaker 41 outputs sound S based on first voice signal s1. Sound collection microphone 50 collects sound S output from speaker 41 via the head of the person. Sound collection microphone 50 outputs second voice signal s2 based on collected sound S.

Controller 60 uses first voice signal s1 output by itself and second voice signal s2 input to itself, and thereby controls the directivities of call microphones 31 and 32. Specifically, controller 60 acquires amount of delay d1 of second voice signal s2 relative to first voice signal s1 to control the directivities of call microphones 31 and 32.

Although amount of delay d1 can be determined by a formula of amount of delay d1=(time at which second voice signal s2 is received)−(time at which first voice signal s1 is transmitted), in Variation 3, amount of delay d1 is determined with consideration given to a communication delay time caused by communication between first communication module 81 and second communication module 82 or the like. For example, in Variation 3, it is assumed that the “time at which first voice signal s1 is transmitted” is not the time at which controller 60 provides instruction for transmitting first voice signal s1 but the time at which controller 60 receives a reception completion notification from second communication module 82. Specifically, second communication module 82 receives first voice signal s1 transmitted from first communication module 81, and the time at which controller 60 receives the reception completion notification returned from second communication module 82 via first communication module 81 is assumed to be the “time at which first voice signal s1 is transmitted”. The “time at which first voice signal s1 is transmitted” is set as described above, and thus it is possible to reduce the influence of the communication delay time caused by communication between the communication modules or the like.

Call signals picked up by call microphones 31 and 32 are subjected to AD conversion and pulse density modulation processing, and are thereafter transmitted from second communication module 82 to first communication module 81. First communication module 81 outputs, to controller 60, the call signals input thereto. Controller 60 performs computation processing shown in FIG. 4A on the call signals, and thereafter transmits the call signals on which the computation processing has been performed to communication terminal 2 via first communication module 81.

Even in Variation 3, speaker 41 outputs sound S based on first voice signal s1, and sound collection microphone 50 collects sound S output from speaker 41 via the head of the person, and outputs, to controller 60, second voice signal s2 based on collected sound S. Then, controller 60 controls the directivities of call microphones 31 and 32 based on amount of delay d1 of second voice signal s2 relative to first voice signal s1. In this way, even when the width of the head of the person wearing headset 1C varies, it is possible to appropriately pick up the voice emitted from the mouth according to the width of the head of the person.

### [Effects and the Like]

As described above, in the present embodiment, headset 1 includes: first housing 10 that is worn on one of ears of a person; second housing 20 that is worn on the other of the ears; a plurality of call microphones 30 that are provided in at least one of first housing 10 or second housing 20; speaker 41 that is provided in first housing 10; the sound collection microphone that is provided in second housing 20; and controller 60 that outputs first voice signal s1 to speaker 41. Speaker 41 outputs sound S based on first voice signal s1. Sound collection microphone 50 collects sound S output from speaker 41 via the head of the person, and outputs, to controller 60, second voice signal s2 based on collected sound S. Controller 60 controls the directivities of call microphones 30 based on amount of delay d1 of second voice signal s2 relative to first voice signal s1.

As described above, speaker 41 outputs sound S based on first voice signal s1, and sound collection microphone 50 collects sound S output from speaker 41 via the head of the person, and outputs second voice signal s2 based on collected sound S, with the result that controller 60 can determine amount of delay d1 of second voice signal s2 relative to first voice signal s1. Controller 60 controls the directivities of call microphones 30 based on amount of delay d1, and thus it is possible to appropriately pick up the voice emitted from the mouth according to the width of the head of the person.

In the present embodiment, controller 60 calculates width w1 of the head based on amount of delay d1, and controls the directivities of call microphones 30 based on width w1 of the head calculated.

As described above, width w1 of the head is calculated based on amount of delay d1, and thus even when the width of the head of the person wearing headset 1 varies, the directivities of call microphones 30 are controlled, with the result that it is possible to pick up the voice emitted from the mouth according to the width of the head of the person.

In the present embodiment, controller 60 controls the directivities of call microphones 30 such that beamform BF indicating the directivities of call microphones 30 overlaps position coordinates PS of the voice emitted from the mouth of the person.

As described above, the directivities of call microphones 30 are controlled, and thus even when the width of the head of the person wearing headset 1 varies, it is possible to pick up the voice emitted from the mouth according to the width of the head of the person.

In the present embodiment, amount of delay d1 is a time difference between a time when controller 60 outputs first voice signal s1 and a time when second voice signal s2 is input to controller 60.

In this way, it is possible to easily determine amount of delay d1. Controller 60 controls the directivities of call microphones 30 based on amount of delay d1, and thus it is possible to appropriately pick up the voice emitted from the mouth according to the width of the head of the person.

In the present embodiment, amount of delay d1 is a phase difference between a signal waveform of first voice signal s1 and a signal waveform of second voice signal s2.

In this way, it is possible to easily determine amount of delay d1. Controller 60 controls the directivities of call microphones 30 based on amount of delay d1, and thus it is possible to appropriately pick up the voice emitted from the mouth according to the width of the head of the person.

In the present embodiment, headset 1 further includes: memory 62 in which a plurality of homeomorphic coefficients for causing call signals output from call microphones 30 to be homeomorphic are stored. In memory 62, homeomorphic coefficients a1 to a4 corresponding to width w0 of the head serving as a standard are stored. Controller 60 compares width w1 of the head calculated and width w0 of the head serving as the standard to correct homeomorphic coefficients a1 to a4 stored in memory 62, and controls the directivities of call microphones 30 based on the homeomorphic coefficients corrected.

As described above, width w1 of the head calculated and width w0 of the head serving as the standard are compared, homeomorphic coefficients a1 to a4 are corrected, and thus even when the width of the head of the person wearing headset 1 varies, the directivities of call microphones 30 are controlled, with the result that it is possible to pick up the voice emitted from the mouth according to the width of the head of the person.

In the present embodiment, headset 1 further includes: memory 62 in which a plurality of homeomorphic coefficients for causing call signals output from call microphones 30 to be homeomorphic are stored. In memory 62, homeomorphic coefficients a1 to a4, b1 to b4, and c1 to c4 that respectively correspond to widths wa, wb, and wc of the head serving as references are stored. Controller 60 selects, according to width w1 of the head calculated, the width (for example, wa) of the head serving as a reference from widths wa to wc of the head serving as the references, acquires the homeomorphic coefficients (for example, a1 to a4) corresponding to the width of the head selected, and controls the directivities of call microphones 30 based on the homeomorphic coefficients that have been acquired.

As described above, the width of the head serving as the reference is selected from widths wa, wb, and wc of the head serving as the references, the homeomorphic coefficients are acquired, and thus even when the width of the head of the person wearing headset 1 varies, the directivities of call microphones 30 are controlled, with the result that it is possible to pick up the voice emitted from the mouth according to the width of the head of the person.

In the present embodiment, headset 1 further includes: communication module 80 that is connected to communicate with external communication terminal 2. Communication module 80 outputs, to controller 60, a signal about a voice transmitted from communication terminal 2. Controller 60 outputs first voice signal s1 based on the signal about the voice output from communication module 80.

In this way, controller 60 utilizes the signal about the voice output from communication module 80, and thereby can control the directivities of call microphones 30. Consequently, it is possible to appropriately pick up the voice emitted from the mouth according to the width of the head of the person.

In the present embodiment, controller 60 controls the directivities of call microphones 30 while receiving second voice signal s2 output from sound collection microphone 50.

In this way, for example, even when the position where first housing 10 or second housing 20 is worn on the head is displaced, it is possible to appropriately pick up the voice emitted from the mouth according to the position described above.

In the present embodiment, call microphones 30 are a microphone array in which two or more microphones are provided as a set.

In this way, controller 60 controls the directivities of call microphones 30, and thereby can appropriately pick up the voice emitted from the mouth according to the width of the head of the person.

In the present embodiment, call microphones 30 are provided in each of first housing 10 and second housing 20.

In this way, controller 60 controls the directivities of call microphones 30 in each of first housing 10 and second housing 20, and thereby can appropriately pick up the voice emitted from the mouth according to the width of the head of the person.

In the present embodiment, a method for controlling the directivities of call microphones 30 includes: outputting sound S based on first voice signal s1 from speaker 41 disposed on the side of one of ears of a person; using sound collection microphone 50 disposed on the side of the other of the ears to collect sound S output from speaker 41 via the head of the person, and outputting second voice signal s2 based on collected sound S; and controlling the directivities of call microphones 30 provided on both sides or one side of the ears based on amount of delay d1 of second voice signal s2 relative to first voice signal s1.

As described above, the directivities of call microphones 30 are controlled based on amount of delay d1 of second voice signal s2 relative to first voice signal s1, and thus it is possible to appropriately pick up the voice emitted from the mouth according to the width of the head of the person.

In order to accurately determine the width of the head, it is desirable to locate speaker 41 and sound collection microphone 50 at both ends of the head in the direction of the width such that a distance between the speaker and the microphone is equal to the width of the head and to measure the time after the output of the sound from speaker 41 until the sound is collected by sound collection microphone 50. In a headset which is actually manufactured, a distance between a speaker and a sound collection microphone may be slightly different from the width of the head, and there may also be a delay in the input/output of signals between controller 60 and speaker 41. It is considered that as in the present embodiment, even when the time after the output of first voice signal s1 from controller 60 until second voice signal s2 is input to controller 60 is measured, sufficient accuracy is achieved. The values in the tables shown in FIGS. 5 to 7 are previously set such that differences therebetween can be absorbed, and thus it is possible to further increase accuracy.

### OTHER EMBODIMENTS

As described above, as examples of techniques in the present disclosure, the embodiment and variations of the embodiment have been described. The accompanying drawings and the detailed description have been provided accordingly.

Hence, constituent elements in the accompanying drawings and the detailed description may include not only essential constituent elements for solving the problem but also constituent elements for illustration of the techniques which are not essential for solving the problem. Therefore, just because the constituent elements which are not essential are described in the accompanying drawings and the detailed description, it should not be immediately considered that the constituent elements which are not essential are essential.

Since the embodiment and variations described above are intended for illustration of the techniques in the present disclosure, various changes, replacements, additions, omissions and the like can be performed in the scope of claims or in a scope equivalent thereto.

Although in the embodiment described above, the example is shown where width w1 of the head is calculated based on amount of delay d1 of second voice signal s2 relative to first voice signal s1, and the directivities of call microphones 30 are thereafter controlled, width w1 of the head does not necessarily need to be calculated. For example, when a correlation between the amount of delay and homeomorphic coefficients is previously stored in memory 62, controller 60 may use the correlation to acquire homeomorphic coefficients for actual amount of delay d1 so as to control the directivities of call microphones 30.

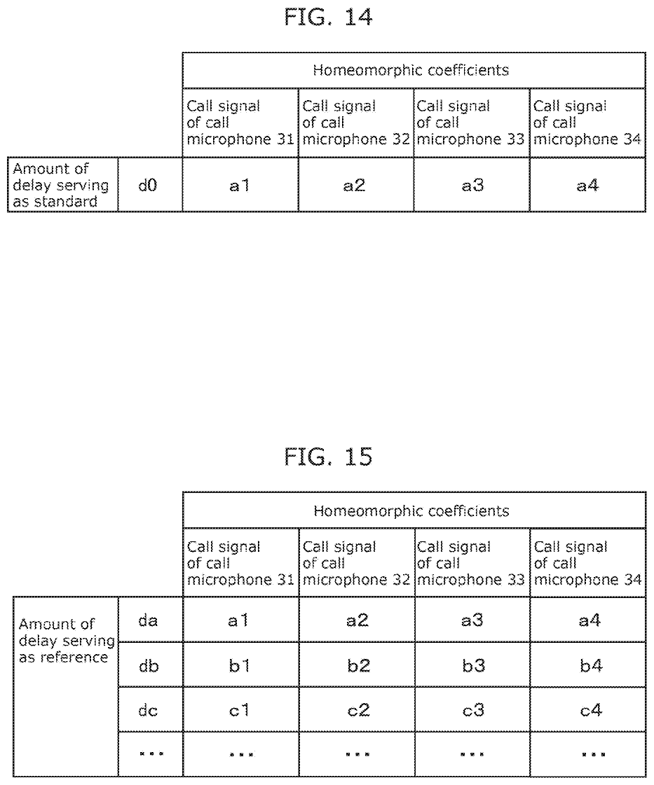

FIG. 14 is a diagram showing another example of the homeomorphic coefficients stored in memory 62 of headset 1. A plurality of homeomorphic coefficients a1 to a4 stored in memory 62 are homeomorphic coefficients corresponding to amount of delay do serving as a standard. Controller 60 may compare amount of delay d1 calculated and amount of delay do serving as the standard to correct homeomorphic coefficients a1 to a4 stored in memory 62, and control the directivities of call microphones 30 based on the corrected homeomorphic coefficients.

FIG. 15 is a diagram showing another example of the homeomorphic coefficients stored in memory 62 of headset 1. In the table of memory 62, a plurality of homeomorphic coefficients a1 to a4, b1 to b4, and c1 to c4 which respectively correspond to amounts of delay da, db, and dc serving as references are stored. Controller 60 may select, according to amount of delay d1 calculated, the amount of delay (for example, da) serving as a reference from amounts of delay da to dc serving as the references, acquire the homeomorphic coefficients (for example, a1 to a4) corresponding to the amount of delay selected, and control the directivities of call microphones 30 based on the homeomorphic coefficients that have been acquired.

Although in the present embodiment, the example is shown where the voice based on first voice signal s1 is output from speaker 41, and no voice is output from speaker 42, the present disclosure is not limited to this example. The voice based on first voice signal s1 may also be output from speaker 42. In this case, sound collection microphone 50 outputs a voice signal (s2a) obtained by collecting a voice transmitted from speaker 41 via the head and a voice transmitted from speaker 42 via air. Hence, for later calculation, it is necessary to previously remove, from this voice signal (s2a), a voice signal (s42) based on the voice from speaker 42. Although the frequency characteristic of first voice signal s1 is changed during the process in which first voice signal s1 is output from speaker 42, is transmitted through air, and is collected by sound collection microphone 50, and the amplitude thereof is attenuated, this characteristic can be known. Controller 60 can reproduce the voice signal (s42) in a pseudo manner by multiplying first voice signal s1 output from speaker 42 by a transfer function reflecting this characteristic. Then, with consideration given to a delay time until first voice signal s1 reaches sound collection microphone 50 from speaker 42 via air, a voice signal obtained by subtracting (adding the signal of the opposite phase) the voice signal (s42) from the voice signal (s2a) is assumed to be second voice signal s2. Second voice signal s2 determined in this way may be used for the later calculation.

Although in the present embodiment, the example is shown where the directivity control is performed in real time while the voice signal which is input is being reproduced, the present disclosure is not limited to this example. For example, when the headset has an adjustment mode for adjusting the directivities of microphones, the directivities may be adjusted by outputting a test signal from speaker 41 in the adjustment mode and collecting it with sound collection microphone 50. Then, after the adjustment, a call operation may be performed in a normal mode. The test signal described above may be white noise including components in all frequency bands or may be a voice signal of music, a voice, or the like which is previously determined. In the adjustment mode, speaker 42 does not need to output sound.

### INDUSTRIAL APPLICABILITY

The present disclosure is applicable to headsets which are worn on human bodies. The present disclosure is also applicable to call devices, such as headphones and an intercom (intercommunication), which are worn on heads.

### REFERENCE SIGNS LIST

1, 1A, 1B, 1C headset
2, 9 communication terminal
5 call system
10 first housing
20 second housing
30, 31, 32, 33, 34 call microphone
41, 42 speaker
50 sound collection microphone
60 controller
60a sensitivity correction processing
60b FFT processing
60c amplification processing with pre-emphasis
60d directivity synthesis processing
60e gain adjustment processing
60f amplification processing with de-emphasis
60g IFFT processing
61 signal processing
62 memory
65 DSP
71, 72, 73, 74, 77 AD converter
76 DA converter
80, 81, 82 communication module
90 headband
a1, a2, a3, a4, b1, b2, b3, b4, c1, c2, c3, c4 homeomorphic coefficient
BF beamform
d0, d1, da, db, dc amount of delay
PS position coordinates of voice
r1, r2 wireless
S sound
s1 first voice signal
s2 second voice signal
w0, w1, wa, wb, wc width of head

1. A headset comprising:
a first housing that is worn on one of ears of a person;
a second housing that is worn on an other of the ears;
a plurality of call microphones that are provided in at least one of the first housing or the second housing;
a speaker that is provided in the first housing;
a sound collection microphone that is provided in the second housing; and
a controller that outputs a first voice signal to the speaker,
wherein the speaker outputs a sound based on the first voice signal,
the sound collection microphone collects the sound output from the speaker via a head of the person, and outputs, to the controller, a second voice signal based on the sound collected, and
the controller controls directivities of the plurality of call microphones based on an amount of delay of the second voice signal relative to the first voice signal.

2. The headset according to claim 1,
wherein the controller calculates a width of the head based on the amount of delay, and controls the directivities of the plurality of call microphones based on the width of the head calculated.

3. The headset according to claim 1,
wherein the controller controls the directivities of the plurality of call microphones to cause a beamform indicating the directivities of the plurality of call microphones to overlap position coordinates of a voice emitted from a mouth of the person.

4. The headset according to claim 1,
wherein the amount of delay is a time difference between a time when the controller outputs the first voice signal and a time when the second voice signal is input to the controller.

5. The headset according to claim 1,
wherein the amount of delay is a phase difference between a signal waveform of the first voice signal and a signal waveform of the second voice signal.

6. The headset according to claim 2, further comprising:
a memory in which a plurality of homeomorphic coefficients for causing call signals output from the plurality of call microphones to be homeomorphic are stored,
wherein the plurality of homeomorphic coefficients corresponding to a width of a head serving as a standard are stored in the memory, and
the controller compares the width of the head calculated and the width of the head serving as the standard, to correct the plurality of homeomorphic coefficients stored in the memory, and controls the directivities of the plurality of call microphones based on the plurality of homeomorphic coefficients corrected.

7. The headset according to claim 2, further comprising:
a memory in which a plurality of homeomorphic coefficients for causing call signals output from the plurality of call microphones to be homeomorphic are stored,
wherein the plurality of homeomorphic coefficients that correspond to widths of heads serving as references are stored in the memory, and
the controller selects, according to the width of the head calculated, a width of the head serving as a reference from the widths of the heads serving as the references, acquires the plurality of homeomorphic coefficients corresponding to the width of the head selected, and controls the directivities of the plurality of call microphones based on the plurality of homeomorphic coefficients acquired.

8. The headset according to claim 1, further comprising:
a communication module that is connected to communicate with an external communication terminal,
wherein the communication module outputs, to the controller, a signal about a voice transmitted from the communication terminal, and
the controller outputs the first voice signal based on the signal about the voice output from the communication module.

9. The headset according to claim 1,
wherein the controller controls the directivities of the plurality of call microphones while receiving the second voice signal output from the sound collection microphone.

10. The headset according to claim 1,
wherein the plurality of call microphones are a microphone array in which two or more microphones are provided as a set.

11. The headset according to claim 10,
wherein the plurality of call microphones are provided in each of the first housing and the second housing.

12. A method for controlling a directivity of a call microphone, the method comprising:
outputting a sound based on a first voice signal from a speaker disposed on a side of one of ears of a person;
collecting the sound output from the speaker via a head of the person and outputting a second voice signal based on the sound collected, using a sound collection microphone disposed on a side of an other of the ears; and
controlling directivities of a plurality of call microphones provided on both sides or one side of the ears based on an amount of delay of the second voice signal relative to the first voice signal.
